(19) United States
(12) Patent Application Publication
(10) Pub. No.: US 2018/0137582 A1
(43) Pub. Date: May 17, 2018

(54) VACTION RENTAL BOOKING AND ADDITIONAL SERVICES

(71) Applicant: Jordan Probert, Lincoln, NE (US)

(72) Inventor: Jordan Probert, Lincoln, NE (US)

(21) Appl. No.: 15/353,649

(22) Filed: Nov. 16, 2016

(51) Int. Cl. G06Q 50/14; G06Q 10/02; G06Q 50/12; G06Q 30/06

(52) U.S. Cl. CPC G06Q 50/14; G06Q 10/02; G06Q 30/0645; G06Q 30/0625; G06Q 50/12

(57) ABSTRACT

In an approach a method for locating vacation rentals, the method comprising creating, by one or more processors, a user account; receiving, by one or more processors, a request for services by the user; offering, by one or more processors, a service by a provider; offering, by one or more processors, additional services offered by the provider; and providing, by one or more processors, the user with additional information related to the service and the additional services.

### BACKGROUND OF THE INVENTION

The present invention relates to in general to tourism and more particularly to a method for providing numerous services to the traveler.

Vacation rentals have been popular among tourists as economic accommodations, in particular for long durations of staying. Vacation rentals also popularly known as villa rentals, villa holidays, self-catering rentals, holiday homes, holiday lets, or cottage holidays are furnished apartments, villas, etc. rented to tourists for short term accommodation. Unlike hotels, the vacation rentals are cheaper and advantageous when the tourist is planning for long-term stay. The owners of vacation rentals generally advertise trough websites, newspaper or travel guides etc. Moreover, numerous service providers have come up filling the gaps between the owner and renter of vacation rentals.

The business of vacation rentals generally involves service providers, which acts as an intermediator between the owners of vacation rentals and persons interested in vacation rentals. The owners of vacation rentals could communicate the availability, occupancy and other details of the vacation rentals to the service provider. The service providers maintain one or more databases referred herein as vacation rentals database, which stores details of the vacation rentals. The databases are generally electronic databases having search capability.

### SUMMARY

Aspects of the present invention disclose a method, computer program product for locating vacation rentals, the method comprising. A processing device creates a user account, wherein the user account. The processing device receives a request for services by the user. The processing device offers a service by a provider. The processing device offers additional services offered by the provider. The processing device provides the user with additional information related to the service and the additional services.

### BRIEF DESCRIPTION OF THE DRAWINGS

FIG. 1 depicts a block diagram of a computing system environment, in accordance with one embodiment of the present invention;

FIG. 2 is a flowchart depicting operational steps of services program within the computer system environment of FIG. 1 for detecting anomalies within transactions, in accordance with one embodiment of the present invention.

FIG. 3 is a block diagram of internal and external components of the server and SQL server of FIG. 1, in accordance with one embodiment of the present invention.

### DETAILED DESCRIPTION

Aspects of the present invention may be embodied as a system, method or computer program product. Embodiments of the present invention are to provide additional services to travelers from the renters to create more services to the traveler to increase their enjoyment of the vacation, while also providing the renter the ability to have additional sources of income.

The program code may execute entirely on a user's computer, partly on the user's computer, as a stand-alone software package, partly on the user's computer and partly on a remote computer or entirely on a remote computer or server. In one embodiment, a remote computer may be connected to the operator's computer through any type of network, including a local area network (LAN) or a wide area network (WAN), or the connection may be made to an external computer (for example, through the Internet using an Internet Service Provider).

The present invention will now be described in detail with reference to the Figures.

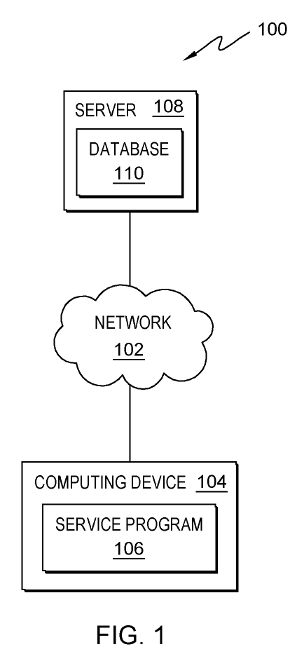

FIG. 1 depicts a block diagram of a computing environment 100 in accordance with one embodiment of the present invention. FIG. 1 provides an illustration of one embodiment and does not imply any limitations regarding the environment in which different embodiments maybe implemented. In the depicted embodiment, computing environment 100 includes network 102, computing device 104, and server 108. As depicted, computing environment 100 provides an environment for service program 106 to access database 110 through network 102. Computing environment 100 may include additional servers, computers, or other devices not shown.

Network 102 may be a local area network (LAN), a wide area network (WAN) such as the Internet, any combination thereof, or any combination of connections and protocols that can support communications between computing device 102 and server 106 in accordance with embodiments of the invention. Network 102 may include wired, wireless, or fiber optic connections.

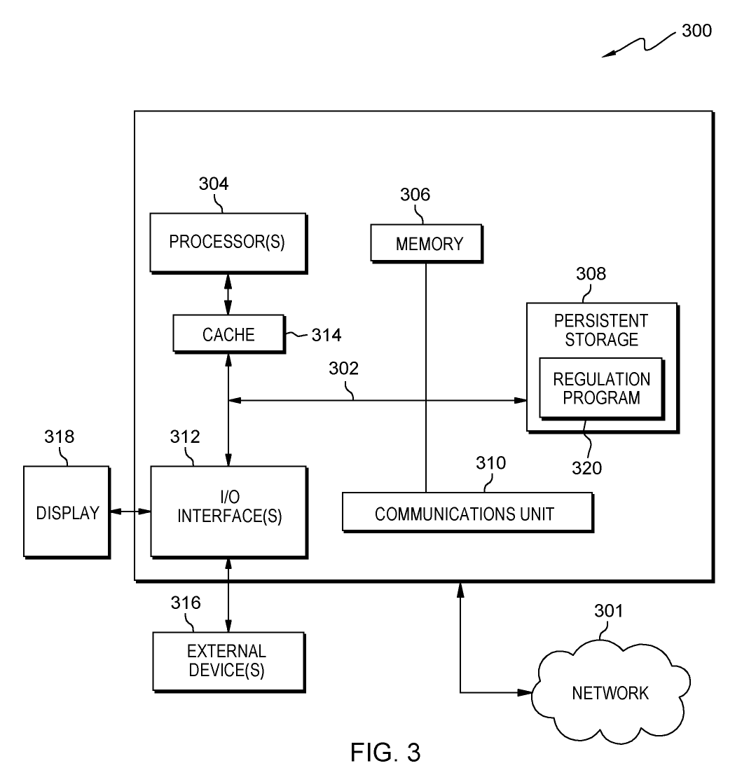

Computing device 104 may be a management server, a web server, or any other electronic device or computing system capable of processing program instructions and receiving and sending data. In some embodiments, computing device 104 may be a laptop computer, tablet computer, netbook computer, personal computer (PC), a desktop computer, or any programmable electronic device capable of communicating with server 106 via network 102. In other embodiments, server 102 may represent a server computing system utilizing multiple computers as a server system, such as in a cloud computing environment. In another embodiment, server 102 represents a computing system utilizing clustered computers and components to act as a single pool of seamless resources. In the depicted embodiment, server 102 includes service program 104. In other embodiments, computing device 104 may include any combination of service program 106 and database 110. Computing device 104 may include components, as depicted and described in further detail with respect to FIG. 3.

Service program 106 operates to perform the actions between the traveler and the renter and provide all available services to the traveler that the renter is offering. In the depicted embodiment, service program 106 utilizes network 102 to access database 110. In one embodiment, service program 106 resides on computing device 104. In other embodiments, service program 106 may be located on another server or computing device, provided service program 106 has access to database 110.

Server 108 may be a management server, a web server, or any other electronic device or computing system capable of processing program instructions and receiving and sending data. In some embodiments, server 108 may be a laptop computer, tablet computer, netbook computer, personal computer (PC), a desktop computer, or any programmable electronic device capable of communicating with computing device 104 via network 102. In other embodiments, server 108 may represent a server computing system utilizing multiple computers as a server system, such as in a cloud computing environment. In another embodiment, server 108 represents a computing system utilizing clustered computers and components to act as a single pool of seamless resources. In some embodiments, the renter may provide all the potential options on server 108. In the depicted embodiment, server 108 includes database 110. In other embodiments, server 108 may include any combination of service program 106, database 106. Server 108 may include components, as depicted and described in further detail with respect to FIG. 3.

Database 110 may be a repository that may be written to and/or read by service program 106. Information gathered from service program 106 may be stored to database 110. Such information may include the renter's available services, and the traveler's requests. In one embodiment, database 110 is a database management system (DBMS) used to allow the definition, creation, querying, update, and administration of a database(s). In the depicted embodiment, database 110 resides on server 108. In other embodiments, database 110 resides on another server, or another computing device, provided that database 110 is accessible to service program 106.

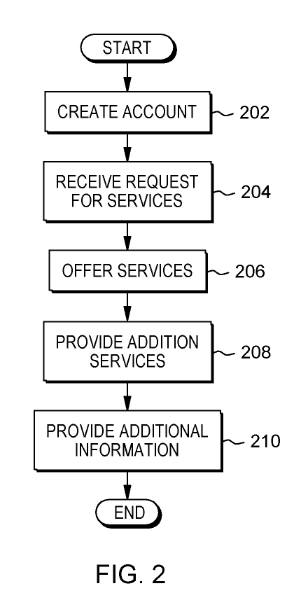

FIG. 2 depicts flowchart 200 of service program 106 executing within computing environment 100 of FIG. 1, in accordance with an embodiment of the present invention. Process 200 represents the process of service program 106 receiving and sending requests and options between the traveler and the renter. As depicted in FIG. 2, process 200 depicts steps performed by service program 106 in receiving a request and sending an option.

In step 202, service program 106 creates an account. A user creates an account and provides information that will be used by the service program 106 to provide the most accurate results for the user. In one embodiment, the service program 106 requests name, address, contact person, price, availability, type of accommodation, desired location. In another embodiment, the service program 106 requests specific locations and properties. In additional embodiments, the account may require a type of payment method, previous bookings and rentals.

In step 204, service program 106 receives request for services. A user sends a request for a service or rental. This can be a request for a rental property, a window of availability, an airline ticket, a car rental, a plurality of available properties or rooms at specific locations or properties, rent amount, duration of stay, type of accommodation, or the like. In some embodiments, this can be contact addresses or phone numbers for particular owners of rental property.

In step 206, service program 106 offers services. Service program 106 takes the received request and generates a plurality of accommodations or services that meet the user's requirements and preferences. In one embodiment, the service program 106 may provide a plurality of results that are within a predetermined threshold of the user's requirements. In additional embodiments, the service program 106 may not have any properties or services that match the user's requirements, so the service program 106 offers services or properties that are relevant and in a predetermined proximately in both location and type to the services or properties requested. In additional embodiment, the service program 106 may provide pictures, maps, images, or the like of the requested services or properties. In another embodiment, the services offered maybe based on the user's previous services selected.

In step 208, service program 106 offers additional services. In one embodiment, the service program 106 may offer a transportation pick up and drop off, tour guide, taxi service, meal preparation and meal services, concierge services, gym services, laundry services, parking services, and the like. In some embodiments, the additional services offered are discounts on the services, or discounts on additional services the user may be interested in.

In step 210, service program 106 offers additional information. In one embodiment, the service program 106 offers information, historic, cultural, events, nightlife, sporting events, festivals, and the like to the user. In another embodiment, the service program 106 may offer discounts on additional items or services if they are bought as a “package.” In another embodiment, the service program 106 allows the owner of the service or the property to communicate with the user to provide information to the travelers about around places of interest, thus the owners may acts as a tour guide to the traveler/renter. The owners may already have a good knowledge about their city and places of interest and further the method may acquaint the owners with information regarding the city. Thus, the owners while providing transportation services to the renter, may also act as their tour guide making the travel experience of the traveler more convenient and economic. The customer would have more trust on the owner of vacation rentals, for services such as transportation and guidance to the place of interest, that any other service provider providing transportation service or a tour guide.

FIG. 3 depicts a block diagram of components of computing device 104 and server 108, in accordance with an illustrative embodiment of the present invention. It should be appreciated that FIG. 5 provides only an illustration of one implementation and does not imply any limitations with regard to the environments in which different embodiments may be implemented. Many modifications to the depicted environment may be made.

Computing device 104 and server 108 include communications fabric 302, which provides communications between computer processor(s) 304, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses.

Memory 306 and persistent storage 308 are computer-readable storage media. In one embodiment, memory 306 includes random access memory (RAM) 314 and cache memory 316. In general, memory 306 can include any suitable volatile or non-volatile computer-readable storage media.

Database 110 is stored for execution by one or more of the respective computer processors 304 of computing device 104 and server 108 via one or more memories of memory 306 of computing device 104 and server 108. In this embodiment, persistent storage 308 includes a magnetic hard disk drive. Alternatively, or in addition to a magnetic hard disk drive, persistent storage 308 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer-readable storage medium that is also part of persistent storage 308.

Communications unit 310, in the examples, provides for communications with other data processing systems or devices, including computing device 104 and server 108. In the examples, communications unit 310 includes one or more network interface cards. Communications unit 310 may provide communications through the use of either or both physical and wireless communications links. Service program 106 may be downloaded to persistent storage 308 of computing device 104 and server 108 through communications unit 310 of computing device 104 and server 108.

I/O interface(s) 312 allows for input and output of data with other devices that may be connected to computing device 104 and server 108. For example, I/O interface 312 may provide a connection to external devices 318 such as a keyboard, keypad, camera, a touch screen, and/or some other suitable input device. External devices 318 can also include portable computer-readable storage media such as, for example, thumb drives, portable optical or magnetic disks, and memory cards. Software and data used to practice embodiments of the present invention, e.g., function of service program 106 can be stored on such portable computer-readable storage media and can be loaded onto persistent storage 308 of computing device 104 and server 108 via I/O interface(s) 312 of computing device 104 and server 108. Software and data used to practice embodiments of the present invention, e.g., service program 106 can be stored on such portable computer-readable storage media and can be loaded onto persistent storage 308 of computing device 104 and server 108 via I/O interface(s) 312 of computing device 104 and server 108. I/O interface(s) 312 also connect to a display 320.

Display 320 provides a mechanism to display data to a user and may be, for example, a computer monitor.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for locating vacation rentals, the method comprising:
creating, by one or more processors, a user account, wherein the user account;
receiving, by one or more processors, a request for services by the user;
offering, by one or more processors, a service by a provider;
offering, by one or more processors, additional services offered by the provider; and
providing, by one or more processors, the user with additional information related to the service and the additional services.

2. The method of claim 1, wherein creating the account further comprises:
providing, by one or more processors, a name, address, contact, price, availability, type of accommodation, and desired location.

3. The method of claim 1, wherein receiving the request for service by the user is related to availability, destination, desired accommodation, duration, rent amount, and the like.

4. The method of claim 1, wherein the provider offers a predetermined number of rentals to the user.

5. The method of claim 1, wherein the provider offers contain a predetermined set of images.

6. The method of claim 1, wherein the additional services offered by the provider are related to the initial service that the user requested.

7. The method of claim 6, wherein the additional services are rides, excursions, packages, and tickets.

8. The method of claim 1 wherein the additional information is related to the selected destination.

9. The method of claim 1, wherein the additional information is related to a predetermined location.

10. A vacation book method comprising:
generating, by one or more processors, hotel room data, wherein the hotel room data comprises:
receiving, by one or more processor, a request from a user, wherein the request is related to predetermined parameters of the hotel room;
comparing, by one or more processors, the request with a set of data about hotel rooms that meet a predetermined factor of the request;
generating, by one or more processors, images and relevant information about the hotel rooms;
after generating the images and relevant information about the hotel rooms, presenting, by one or more processors, the images and relevant information to the user; and
in response to the user selecting one of the hotel rooms, providing, by one or more processors, a plurality of relevant information about the selected hotel room and the proximate area.

11. The method of claim 10, wherein the relevant information is related to the culture, life, events, and experiences in the area proximate of the selected hotel room.

12. A computer program product locating vacation rentals, the method comprising:
one or more computer readable storage media and program instructions stored on the one or more computer readable storage media, the program instructions comprising:
program instructions to create a user account, wherein the user account;
program instructions to receive a request for services by the user;
program instructions to offer a service by a provider;
program instructions to offer additional services offered by the provider; and
program instructions to provide the user with additional information related to the service and the additional services.

13. The method of claim 12, wherein creating the account further comprises:
computer instructions to provide a name, address, contact, price, availability, type of accommodation, and desired location.

14. The method of claim 12, wherein receiving the request for service by the user is related to availability, destination, desired accommodation, duration, rent amount, and the like.

15. The method of claim 12, wherein the provider offers a predetermined number of rentals to the user.

16. The method of claim 12, wherein the provider offers contain a predetermined set of images.

17. The method of claim 1, wherein the additional services offered by the provider are related to the initial service that the user requested.

18. The method of claim 17, wherein the additional services are rides, excursions, packages, and tickets.

19. The method of claim 12 wherein the additional information is related to the selected destination.
